(19) United States
(12) Patent Application Publication
(10) Pub. No.: US 2017/0050640 A1
(43) Pub. Date: Feb. 23, 2017

(54) SHIFT CONTROL APPARATUS OF VEHICLE AUTOMATIC TRANSMISSION

(71) Applicant: TOYOTA JIDOSHA KABUSHIKI KAISHA, Toyota-shi, Aichi-ken (JP)

(72) Inventor: Shuji TOYOKAWA, Toyota-shi (JP)

(73) Assignee: TOYOTA JIDOSHA KABUSHIKI KAISHA, Toyota-shi, Aichi-ken (JP)

(21) Appl. No.: 15/307,533

(22) PCT Filed: May 8, 2015
(86) PCT No.: PCT/IB2015/000871

§ 371 Date: Oct. 28, 2016

(30) Foreign Application Priority Data
May 12, 2014 (JP) 2014-098972

(51) Int. Cl. B60W 30/188; B60W 10/115; B60W 10/02; F16H 3/66; B60W 10/06

(52) U.S. Cl. CPC B60W 30/188; F16H 3/663; B60W 10/06; B60W 10/02; B60W 10/115; F16H 2200/0052; F16H 2200/201; F16H 2200/2023; F16H 2200/2043; F16H 2200/2066; F16H 2200/2082; B60W 2510/1005; B60W 2510/107; B60W 2710/0644; B60W 2710/027

(57) ABSTRACT

In a vehicle automatic transmission having structure in which an output-side rotating element is provided between a speed increasing-side rotating element that is connected to an engine via input clutch and increased rotation speed during downshift into a predetermined speed, and a speed reducing-side rotating element that is reduced in rotation speed by a second engagement apparatus being engaged during the downshift, in an alignment graph, the first engagement apparatus is engaged when, or after, the second engagement apparatus is engaged at the time of the downshift into the predetermined speed. As a result, the rotation speed of the speed reducing-side rotating element is reduced first by the engagement of the second engagement apparatus, which causes driving force to act on the output-side rotating element in a direction that reduces the rotating speed thereof. As a result, forward driving force is prevented from being generated by the output-side rotating element.

### BACKGROUND OF THE INVENTION

1. Field of the Invention

The invention relates to shift control apparatus of a vehicle automatic transmission, and more particularly, to technology for preventing forward driving force that is generated during a downshift from being generated.

2. Description of Related Art

Control has been proposed which, when executing a downshift in a vehicle automatic transmission having a planetary gear set, engages a first engagement apparatus that selectively disengages an engine from the vehicle automatic transmission, and a second engagement apparatus that is to be engaged after the downshift, after the engine speed is increased, while the first engagement apparatus is released or partially engaged. Japanese Patent Application Publication No. 2000-314474 (JP 2000-314474 A) describes technology that has a first engagement apparatus that selectively disengages a driving source from an automatic transmission, and which controls the first engagement apparatus to a released or partially engaged state during a downshift, and increases a rotation speed of a rotating element connected to a predetermined rotating element of the automatic transmission via the first engagement apparatus so that the rotation speed is synchronized with a rotation speed according to the gear ratio after the downshift. Also, JP 2000-314474 A also describes the execution of opening amount control of a throttle valve of an engine that serves as a driving source connected to this rotating element, for example, when controlling the rotation speed of the rotating element that is connected to the automatic transmission via this first engagement apparatus.

An automatic transmission configured with an output-side rotating element provided between a speed increasing-side rotating element that is connected to the engine via a first engagement apparatus and increases in rotation speed after a downshift, and a speed reducing-side rotating element that is reduced in rotation speed by a second engagement apparatus being engaged after a downshift, in a well-known alignment graph that shows the rotational state of each rotating element of the automatic transmission, has been realized. When executing this control in an automatic transmission having this kind of structure, after the first engagement apparatus is released or partially engaged, the rotation speed of the rotating element on the engine side (upstream side) of the first engagement apparatus is increased by opening amount control of the throttle valve of the engine, or the like. Then, the first engagement apparatus, and the second engagement apparatus that reduces the rotation speed of the speed reducing-side rotating element, are engaged, but no mention is given to the order of engagement of the first engagement apparatus and the second engagement apparatus. Here, if the first engagement apparatus is engaged first while the first engagement apparatus is released or partially engaged and the rotation speed of the engine-side rotating element of the first engagement apparatus is increased, the rotation speed of the speed increasing-side rotating element will increase and the speed reducing-side rotating element will function as a reaction force element, so forward driving force will act on the output-side rotating element that is between the speed reducing-side rotating element and the speed increasing-side rotating element on the alignment graph. During a downshift in this kind of automatic transmission, the generation of forward driving force by the output-side rotating element is undesirable, so it is necessary to prevent the generation of this forward driving force during a downshift.

### SUMMARY OF THE INVENTION

In view of the foregoing situation, the invention provides a shift control apparatus of a vehicle automatic transmission provided with a planetary gear set, which is capable of preventing the generation of forward driving force that is generated during a downshift, when executing control that increases the engine speed while releasing or partially engaging a first engagement apparatus at the time of the downshift.

A first aspect of the invention thus relates to a shift control apparatus of a vehicle automatic transmission. This vehicle automatic transmission includes a planetary gear set, a speed increasing-side rotating element, a speed reducing-side rotating element, and an output-side rotating element. The planetary gear set has a first engagement apparatus and a second engagement apparatus. The speed increasing-side rotating element is configured to be connected to an engine via the first engagement apparatus and increased in rotation speed during a downshift into a predetermined speed, in an alignment graph showing a rotational state of each rotating element of the vehicle automatic transmission. The speed reducing-side rotating element is configured to be reduced in rotation speed by the second engagement apparatus being engaged during the downshift into the predetermined speed. The output-side rotating element is provided between the speed increasing-side rotating element and the speed reducing-side rotating element. The shift control apparatus comprises a controller. This controller is configured to increase an engine speed of the engine while reducing a torque capacity of the first engagement apparatus that is engaged before the downshift and after the downshift, during the downshift into the predetermined speed of the vehicle automatic transmission. The controller is also configured to increase the torque capacity of the first engagement apparatus when, or after, engaging the second engagement apparatus.

Accordingly, in a vehicle automatic transmission having a structure in which an output-side rotating element is provided between a speed increasing-side rotating element that is connected to an engine via an input clutch and increased in rotation speed during a downshift into a predetermined speed, and a speed reducing-side rotating element that is reduced in rotation speed by a second engagement apparatus being engaged during the downshift into the predetermined speed, in an alignment graph, the torque capacity of the first engagement apparatus is increased when, or after, the second engagement apparatus is engaged at the time of the downshift into the predetermined speed. As a result, the rotation speed of the speed reducing-side rotating element is reduced first by this increase in the torque capacity of the second engagement apparatus, which causes driving force to act on the output-side rotating element in a direction that reduces the rotating speed thereof. As a result, forward driving force is prevented from being generated by the output-side rotating element. Also, the torque capacity of the first engagement apparatus then increased, but at this time, the rotation speed of the speed increasing-side rotating element increases with the progression of the shift, so when the torque capacity of the first engagement apparatus is increased, the rotation speed of the speed increasing-side rotating element will not increase and forward driving force will not be generated by the output-side rotating element. Therefore, it is possible to prevent forward driving force from being generated by the output-side rotating element during the downshift.

Also, in the shift control apparatus of the vehicle automatic transmission described above, the controller may be configured to start increasing the torque capacity of the first engagement apparatus after a predetermined period of time has passed from a start of engagement of the second engagement apparatus at the time of the downshift of the vehicle automatic transmission. Accordingly, the torque capacity of the second engagement apparatus is increased before the torque capacity of the first engagement apparatus is at the time of the downshift, so it is possible to prevent forward driving force generated as a result of the first engagement apparatus being engaged first, from being generated.

Also, in the shift control apparatus of the vehicle automatic transmission, the controller may be configured to set the predetermined period of time based on the time at which the second engagement apparatus starts to be engaged. Also, the controller may be configured to set the predetermined period of time based on the time at which an inertia phase starts at the time of the downshift.

Moreover, the controller may be configured to set the predetermined period of time based on a point when an engagement hydraulic pressure of the second engagement apparatus reaches a target hydraulic pressure of the second engagement apparatus set after the downshift. Also, the controller may be configured to set the predetermined period of time based on a point when the rotation speed of the speed increasing-side rotating element during the downshift is synchronized with a target rotation speed of the speed increasing-side rotating element after the downshift. Also, in the shift control apparatus of the vehicle automatic transmission described above, the controller may be configured to set the predetermined period of time based on an oil temperature of the vehicle automatic transmission.

As described above, according to the shift control apparatus of the vehicle automatic transmission, the torque capacity of the first engagement apparatus is increased when, or after, engaging the second engagement apparatus at the time of a downshift, i.e., the torque capacity of the second engagement apparatus is increased when, or before, engaging the first engagement apparatus at the time of the downshift, so it is possible to prevent forward driving force generated as a result of the first engagement apparatus being engaged first, from being generated.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a skeleton view of a torque converter and a vehicle automatic transmission that are part of a vehicle power transmitting apparatus to which the invention is applied, interposed in a power transmission path between an engine and driving wheels, and a block diagram illustrating a control operation of an electronic control unit that controls this vehicle automatic transmission;

FIG. 2 is a clutch and brake application chart illustrating the operating states of friction engagement apparatuses that establish each speed in the automatic transmission in FIG. 1;

FIG. 3 is an alignment graph illustrating, with straight lines, the rotation speed of each rotating element of a first transmitting portion and a second transmitting portion in the automatic transmission in FIG. 1;

FIG. 4 is an alignment graph illustrating a downshift from a second speed to a first speed, in particular, in FIG. 3;

FIG. 5 is a secondary map showing the relationship between delay time and oil temperature;

FIG. 6 is a flowchart illustrating a main portion of a control operation of the electronic control unit in FIG. 1, i.e., a control operation that prevents forward driving force that is transmitted to an output rotating member during a downshift in the automatic transmission from being generated; and

FIG. 7 is a time chart showing the result of the control operation based on the electronic control unit in FIG. 1, i.e., the operation result based on the flowchart in FIG. 6.

### DETAILED DESCRIPTION OF EMBODIMENTS

Hereinafter, example embodiments of the invention will be described in detail with reference to the accompanying drawings. The drawings described in the example embodiment below have been simplified or modified as appropriate, so the scale ratios and the shapes and the like of the portions are not always accurately depicted.

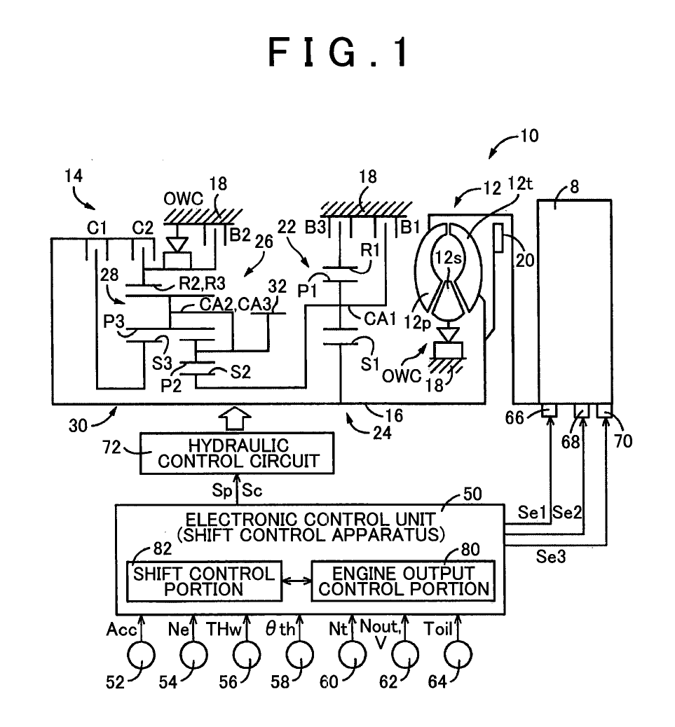

FIG. 1 is a skeleton view of a torque converter 12 and a vehicle automatic transmission 14 (hereinafter, simply referred to as “automatic transmission 14”) that are part of a vehicle power transmitting apparatus 10 to which the invention is applied, interposed in a power transmission path between an engine 8 and driving wheels, not shown.

The torque converter 12 is interposed between the engine 8 and the automatic transmission 14. The torque converter 12 is a well-known fluid power transmitting device that includes a pump impeller 12p that is connected to the engine 8, a turbine runner 12t that is connected to a turbine shaft 16 of the automatic transmission 14, and a stator 12s that is connected to a case 18 that is a non-rotating member via a one-way clutch OWC. A lock-up clutch 20 that selectively disengages the pump impeller 12p from the turbine runner 12t is also provided.

The automatic transmission 14 includes a first transmitting portion 24 and a second transmitting portion 30 arranged on a common axis inside the case 18. The first transmitting portion 24 is mainly formed by a single pinion type first planetary gear set 22. The second transmitting portion 30 has a Ravigneaux type configuration that mainly includes a double pinion type second planetary gear set 26 and a single pinion type third planetary gear set 28. The first planetary gear set 22, the second planetary gear set 26, and the third planetary gear set 28 are each an example of the planetary gear set of the invention.

The first planetary gear set 22 includes a first sun gear S1, first planetary gears P1, a first carrier CA1 that rotatably and revolvably supports these first planetary gears P1, and a first ring gear R1 that is in mesh with the first sun gear S1 via the first planetary gears P1.

The second planetary gear set 26 includes a second sun gear S2, a plurality of pairs of second planetary gears P2 that are in mesh with one another, a second carrier CA2 that rotatably and revolvably supports these secondary planetary gears P2, and a second ring gear R2 that is in mesh with the second sun gear S2 via the second planetary gears P2.

The third planetary gear set 28 includes a third sun gear S3, third planetary gears P3, a third carrier CA3 that rotatably and revolvably supports these third planetary gears P3, and a third ring gear R3 that is in mesh with the third sun gear S3 via the third planetary gears P3.

The second transmitting portion 30 has a so-called Ravigneaux type configuration in which the second carrier CA2 and the third carrier CA3 are connected together and shared, and the second ring gear R2 and the third ring gear R3 are connected together and shared. Having the second transmitting portion 30 be formed by a Ravigneaux type planetary gear set in this way makes the second transmitting portion 30 compact.

The first sun gear S1 of the first planetary gear set 22 is connected to the turbine shaft 16. The first carrier CA1 is connected to the second sun gear S2 of the second planetary gear set 26, and is configured to be selectively connectable to the case 18 that is a non-rotatable member, via a first brake B1. The first ring gear R1 of the first planetary gear set 22 is configured to be selectively connectable to the case 18 via a third brake B3. The second carrier CA2 of the second planetary gear set 26 and the third carrier CA3 of the third planetary gear set 28 are connected together, and connected to an output rotating member 32. The second ring gear R2 of the second planetary gear set 26 and the third ring gear R3 of the third planetary gear set 28 are both formed by a common member, and are configured to be selectively connectable to the case 18 via a second brake B2, as well as configured to be selectively connectable to the turbine shaft 16 via a second clutch C2. Further, the second ring gear R2 and the third ring gear R3 are connected to the case 18 via the one-way clutch OWC that is provided in parallel with the second brake B2. The third sun gear S3 of the third planetary gear set 28 is configured to be selectively connectable to the turbine shaft 16 via a first clutch C1.

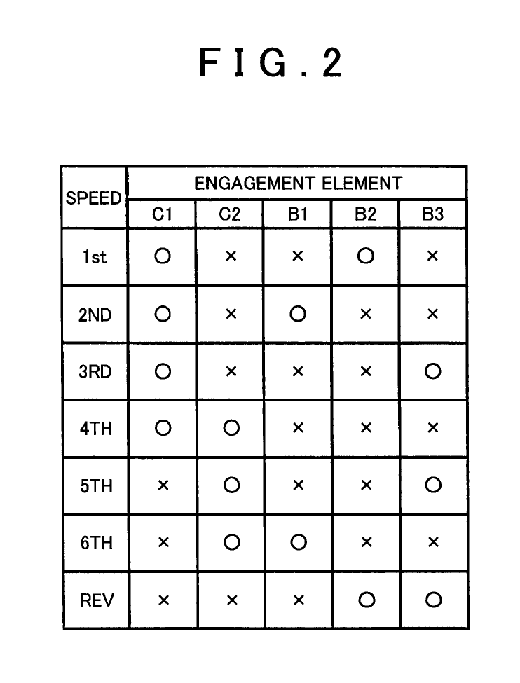

The automatic transmission 14 includes the two clutches C1 and C2, and the three brakes B1 to B3 described above (hereinafter, unless otherwise specified, these will simply be referred to as “clutches C” and “brakes B”). In the automatic transmission 14, the connective states of the rotating elements (i.e., the sun gears S1 to S3, the carriers CA1 to CA3, and the ring gears R1 to R3) of the first transmitting portion 24 and the second transmitting portion 30 are changed by engaging and releasing each of these clutches C and brakes C, to establish six forward speeds (gear speeds), i.e., first speed “1st” to sixth speed “6th”, and a reverse speed “Rev”. The clutches C and brakes B are friction engagement apparatuses, such as multidisc clutches and brakes, that are controlled to engage by hydraulic actuators. Each clutch C and brake B is switched between an engaged state and a released state, and the transient hydraulic pressure during engagement and release is controlled. FIG. 2 is a clutch and brake application chart illustrating the operating states of the friction engagement apparatuses when establishing each speed described above. In the chart, “0” indicates an engaged state and “x” indicates a released state.

In FIG. 2, with the forward speeds, first speed “1st” is established by engaging the first clutch C1 and the second brake B2, second speed “2nd” is established by engaging the first clutch C1 and the first brake B1, third speed “3rd” is established by engaging the first clutch C1 and the third brake B3, fourth speed “4th” is established by engaging the first clutch C1 and the second clutch C2, fifth speed “5th” is established by engaging the second clutch C2 and the third brake B3, and sixth speed “6th” is established by engaging the second clutch C2 and the first brake B1. Also, reverse speed “Rev” is established by engaging the second brake B2 and the third brake B3, and neutral “N” that interrupts the transmission of power is established by releasing all of the clutches C1 and C2 and brakes B1 to B3. The gear ratio (=rotation speed Nt of the turbine shaft 16/rotation speed Nout of the output rotating member 32) of each speed is determined according to the gear ratios (=number of teeth on the sun gear/number of teeth on the ring gear) ρ1, ρ2, and ρ3 of the first planetary gear set 22, the second planetary gear set 26, and the third planetary gear set 28. The gear ratio γ of first speed “1st” is the largest, and the gear ratio γ becomes smaller toward the higher speed side (i.e., the sixth speed “6th” side).

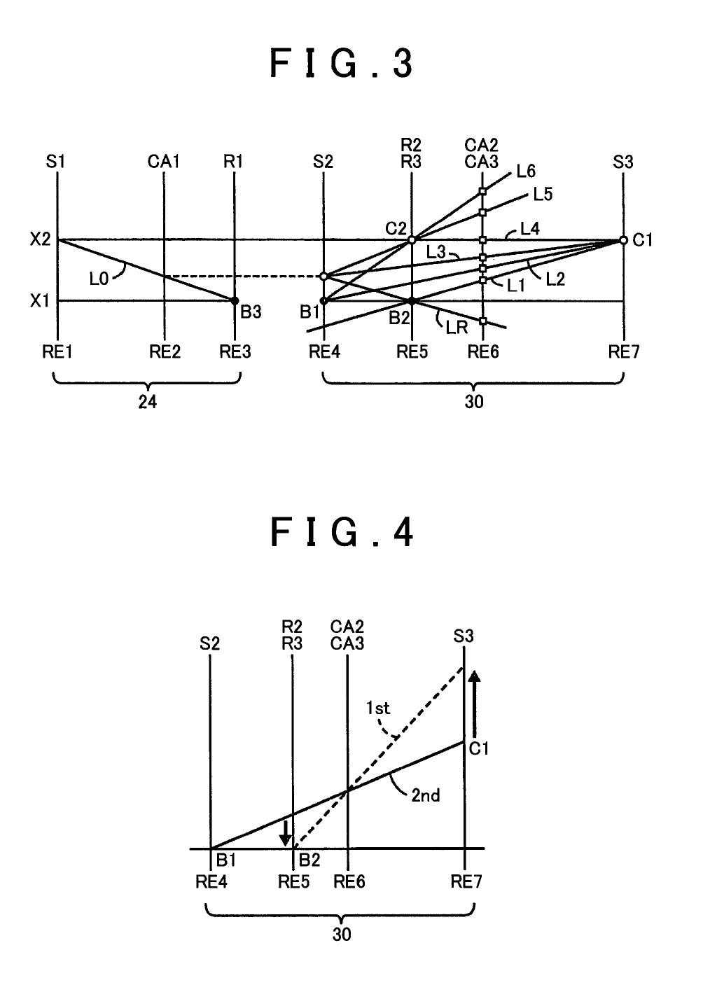

FIG. 3 is an alignment graph that is able to illustrate, with straight lines, the rotation speed of each rotating element of the first transmitting portion 24 and the second transmitting portion 30. In FIG. 3, the lower horizontal line X1 represents a rotation speed of “0”, and the upper horizontal line X2 represents a rotation speed of “1.0”, i.e., the same rotation speed as the turbine shaft 16. Also, the three vertical lines of the first transmitting portion 24 represent, in order from the left side, a first rotating element RE1 formed by the first sun gear S1, a second rotating element RE2 formed by the first carrier CA1, and a third rotating element RE3 formed by the first ring gear R1. Also, the straight line L0 indicates the rotational state of each rotating element when the third brake B3 is engaged. More specifically, when the turbine rotation speed Nt of the turbine shaft 16 is input to the first rotating element RE1 (i.e., the first sun gear S1) and the third brake B3 is engaged, the third rotating element RE3 (i.e., the first ring gear R1) is stopped from rotating. Also, the rotation speed of the first carrier CA1 that is the second rotating element RE2 is indicated by a point of intersection between the straight line L0 and the vertical line corresponding to the second rotating element RE2. The intervals between the vertical lines are determined according to the gear ratio (=the number of teeth on the sun gear/the number of teeth on the ring gear) ρ1 of the first planetary gear set 22.

The four vertical lines of the second transmitting portion 30 represent, in order from the left side, a fourth rotating element RE4 formed by the second sun gear S2, a fifth rotating element RE5 formed by the second ring gear R2 and the third ring gear R3 that are connected together, a sixth rotating element RE6 formed by the second carrier CA2 and the third carrier CA3 that are connected together, and a seventh rotating element RE7 formed by the third sun gear S3. The intervals between these vertical lines are determined according to the gear ratio ρ2 of the second planetary gear set 26 and the gear ratio ρ3 of the third planetary gear set 28.

Next, the speeds of the automatic transmission 14 will be described based on this alignment graph. When both the first clutch C1 and the second brake B2 are engaged, the rotation of the turbine shaft 16 is input to the seventh rotating element RE7 (i.e., the third sun gear S3), and the fifth rotating element RE5 (i.e., the second ring gear R2 and the third ring gear R3) is stopped from rotating. At this time, the rotational state of the second transmitting portion 30 is indicated by the straight line L1, and the sixth rotating element RE6 (i.e., the second carrier CA2 and the third carrier CA3) that is connected to the output rotating member 32 is rotated at a rotation speed indicated by the point of intersection of this straight line L1 and the vertical line corresponding to the sixth rotating element RE6, and first speed 1st that has the largest gear ratio (=the rotation speed Nt of the turbine shaft 16/the rotation speed Nout of the output rotating member 32) is consequently established.

Also, when both the first clutch C1 and the first brake B1 are engaged, the rotation of the turbine shaft 16 is input to the seventh rotating element RE7 (i.e., the third sun gear S3), and the fourth rotating element RE4 (i.e., the second sun gear S2) is stopped from rotating. At this time, the rotational state of the second transmitting portion 30 is indicated by the straight line L2, and the sixth rotating element RE6 that is connected to the output rotating member 32 is rotated at a rotation speed indicated by the point of intersection of this straight line L2 and the vertical line corresponding to the sixth rotating element RE6, and second speed 2nd is consequently established.

Also, when both the first clutch C1 and the third brake B3 are engaged, the rotation of the turbine shaft 16 is input to the seventh rotating element RE7 (i.e., the third sun gear S3), and the third rotating element RE3 (i.e., the first ring gear R1) of the first transmitting portion 24 is stopped from rotating. At this time, in the first transmitting portion 24, the second rotating element RE2 (i.e., the first carrier CA1) is rotated at the rotation speed indicated by the point of intersection with the straight line L0, so the fourth rotating element RE4 (i.e., the second sun gear S2) that is connected to the second rotating element RE2 is also rotated at the same speed. Therefore, the rotational state of the second transmitting portion 30 is indicated by the straight line L3, and the sixth rotating element RE6 that is connected to the output rotating member 32 is rotated at the rotation speed indicated by the point of intersection of the straight line L3 and the vertical line corresponding to the sixth rotating element RE6, and third speed 3rd is consequently established.

Also, when both the first clutch C1 and the second clutch C2 are engaged, the rotation of the turbine shaft 16 is input to both the fifth rotating element RE5 (i.e., the second ring gear R2 and the third ring gear R3) and the seventh rotating element RE7 (i.e., the third sun gear S3) in the second transmitting portion 30. At this time, the rotational state of the second transmitting portion 30 is indicated by the straight line L4 (the horizontal line L4), and the sixth rotating element RE6 that is connected to the output rotating member 32 is rotated at a rotation speed of “1.0” indicated by the point of intersection of this straight line L4 and the vertical line corresponding to the sixth rotating element RE6, and fourth speed 4th that has a gear ratio of 1.0 is consequently established.

Further, when both the second clutch C2 and the third brake B3 are engaged, the rotation of the turbine shaft 16 is input to the fifth rotating element RE5 (i.e., the second ring gear R2 and the third ring gear R3), and rotation at the same rotation speed as the rotation speed of the second rotating element RE2 (i.e., the first carrier CA1) (i.e., the rotation speed indicated by the point of intersection of the straight line L0 and the vertical line corresponding to the second rotating element RE2) is input to the fourth rotating element RE4 (i.e., the second sun gear S2). At this time, the rotational state of the second transmitting portion 30 is indicated by the straight line L5, and the sixth rotating element RE6 that is connected to the output rotating member 32 is rotated at a rotation speed indicated by the point of intersection of this straight line L5 and the vertical line corresponding to the sixth rotating element RE6, and fifth speed 5th is consequently established.

Also, when both the second clutch C2 and the first brake B1 are engaged, the rotation of the turbine shaft 16 is input to the fifth rotating element RE5 (i.e., the second ring gear R2 and the third ring gear R3), and the fourth rotating element RE4 (i.e., the second sun gear S2) is stopped from rotating, in the second transmitting portion 30. At this time, the rotational state of the second transmitting portion 30 is indicated by the straight line L6, and the sixth rotating element RE6 that is connected to the output rotating member 32 is rotated at a rotation speed indicated by the point of intersection of this straight line L6 and the vertical line corresponding to the sixth rotating element RE6, and sixth speed 6th is consequently established.

Also, when both the second brake B2 and the third brake B3 are engaged, both the third rotating element RE3 (i.e., the first ring gear R1) and the fifth rotating element RE5 (i.e., the second ring gear R2 and the third ring gear R3) are stopped from rotating. At this time, the rotational state of the second transmitting portion 30 is indicated by the straight line LR, and the sixth rotating element RE6 that is connected to the output rotating member 32 is rotated at a rotation speed indicated by the point of intersection of this straight line LR and the vertical line corresponding to the sixth rotating element RE6, and reverse speed Rev is consequently established.

The automatic transmission 14 structured as described above is controlled based on commands output from an electronic control unit 50 (one example of the shift control apparatus of the invention) shown in FIG. 1. The electronic control unit 50 includes a so-called microcomputer that includes a CPU, RAM, ROM, and an input/output interface and the like. The CPU executes output control of the engine 8, shift control of the automatic transmission 14, and ON/OFF control of the lock-up clutch 20, and the like, by processing signals according to a program stored in the ROM beforehand, while using the temporary storage function of the RAM. This electronic control unit 50 may also be configured divided up into portions for engine control and shift control and the like as necessary.

Various signals are supplied to the electronic control unit 50. These signals include, for example, an accelerator operation amount signal indicative of an accelerator operation amount Acc that is the operation amount of an accelerator pedal detected by an accelerator operation amount sensor 52, a signal indicative of an engine speed Ne that is the rotation speed of the engine 8 detected by an engine speed sensor 54, a signal indicative of a coolant temperature THw of the engine 8 detected by a coolant temperature sensor 56, a throttle valve opening amount signal indicative of an opening amount θth of an electronic throttle valve detected by a throttle valve opening amount sensor 58, a signal indicative of a turbine rotation speed Nt that is the rotation speed of the turbine shaft 16 detected by a turbine rotation speed sensor 60, a vehicle speed signal corresponding to the rotation speed Nout of the output rotating member 32, i.e., a vehicle speed V, detected by a vehicle speed sensor 62, and a signal indicative of an oil temperature Toil of the operating fluid of the automatic transmission 14 detected by an oil temperature sensor 64.

Also, various engine control signals are output from the electronic control unit 50. Examples of these engine control signals include a drive signal Se1 to a throttle actuator 66 that operates the opening amount θth of the electronic throttle valve, an ignition command signal Se2 to an ignition device 68 that controls the ignition timing of the engine 8, and a fuel supply amount signal Se3 that controls the amount of fuel supplied to the engine 8 by a fuel injection device 70 that supplies or stops the supply of fuel into a cylinder or intake pipe of the engine 8. Various other signals are also output from the electronic control unit 50, such as a shift control signal Sc that controls a linear solenoid valve in a hydraulic control circuit 72 to switch speeds of the automatic transmission 14, and a lock-up control signal Sp for driving a linear solenoid valve that controls the engagement state of the lock-up clutch 20.

The electronic control unit 50 functionally includes an engine output control portion 80 and a shift control portion 82. The engine output control portion 80 controls the electronic throttle valve open and closed according to the accelerator operation amount Acc using the throttle actuator, such that engine output increases as the accelerator operation amount Acc increases. The engine output control portion 80 executes output control of the automatic transmission 14, e.g., controls the fuel injection amount by the fuel injection device 70 for fuel injection control, and controls the ignition timing by the ignition device 68 such as an igniter for ignition timing control.

The shift control portion 82 is designed to perform shift control and neutral control and the like of the automatic transmission 14. This shift control portion 82 controls shifts among the different speeds, i.e., first speed “1st” to sixth speed “6th”, establishes the reverse speed “Rev”, and places the automatic transmission in neutral “N” by releasing all of the clutches C and brakes B, by referencing the actual vehicle speed and accelerator operation amount Acc, according to a shift map that includes vehicle speeds V and accelerator operation amounts Acc obtained and stored in advance.

Upon receiving a command to execute a downshift based on the shift map, for example, the shift control portion 82 and the engine output control portion 80 execute so-called blipping downshift control that increases the engine speed Ne while temporarily reducing the torque capacity of an input clutch C (the first clutch C1 or the second clutch C2 in this example embodiment) that connects the automatic transmission 14 to the turbine shaft 16 and is engaged before and after the downshift, in conjunction with downshift control that releases a friction engagement apparatus to be released during the downshift and engages a friction engagement apparatus to be engaged during the downshift.

Upon receiving a command to execute a downshift, the shift control portion 82 outputs a command to the hydraulic control circuit 72 to release the friction engagement apparatus to be released during the downshift of the automatic transmission 14 (hereinafter, this friction engagement apparatus will be referred to as a “releasing-side engagement apparatus”), and start engaging the friction engagement apparatus to be engaged during the downshift (hereinafter, this friction engagement apparatus will be referred to as an “engaging-side engagement apparatus”). In conjunction with this, the shift control portion 82 outputs a command to the hydraulic control circuit 72 to temporarily reduce the torque capacity of the input clutch C (which corresponds to the first clutch C1 or the second clutch C2 in this example embodiment) that is engaged before and after the downshift. The input clutch C that is engaged before and after the downshift is the same clutch that is engaged before (immediately before) the downshift and after (immediately after) the downshift. For example, in a downshift from second speed 2nd to first speed 1st, the first clutch C1 that is engaged in second speed 2nd and first speed 1st corresponds to this input clutch C.

Furthermore, the engine output control portion 80 outputs a command to increase the engine speed Ne, at the same time as, or after a slight delay time after, the torque capacity of the input clutch C starts to be reduced. The engine output control portion 80 increases the engine speed Ne by, for example, increasing the opening amount of the electronic throttle valve by the throttle actuator 66. The engine speed Ne is controlled to match a rotation speed Nt* (a target rotation speed Nt*) that the turbine rotation speed Nt of the turbine shaft 16 is set to after the downshift, or a value near there. The input clutch that is engaged before and after the downshift (i.e., the first clutch C1 or the second clutch C2) is one example of the first engagement apparatus of the invention. The engaging-side engagement apparatus is one example of the second engagement apparatus of the invention.

As a result of this blipping downshift control being executed, the turbine rotation speed Nt of the turbine shaft 16 that is to be connected to the automatic transmission 14 via the input clutch C after the downshift is increased in advance with the increase in the engine speed Ne. Also, the load applied while the engine speed Ne is increased is also reduced by the torque capacity of the input clutch C being temporarily reduced, so the turbine rotation speed Nt increases in a short amount of time. The shift duration of the downshift is able to be shortened by increasing the turbine rotation speed Nt in a short amount of time in this way.

When executing the blipping downshift control described above, the engaging-side engagement apparatus to be engaged during the downshift, and the input clutch C (i.e., the first clutch C1 or the second clutch C2) in which the torque capacity is reduced during the downshift, are both engaged. In this way, during a downshift, the engaging-side engagement apparatus and the input clutch C are engaged, but the order in which they are engaged was not defined in any way.

Here, if in the downshift transition the input clutch C in which the torque capacity is reduced during the downshift is engaged before the engaging-side engagement apparatus to be engaged during the downshift is engaged, the problem described below will occur. In the description below, an example of a downshift from second speed 2nd to first speed 1st (a predetermined speed) in the automatic transmission 14 will be described. In this downshift from second speed 2nd to first speed 1st, of the first clutch C1 and the second clutch C2, the first clutch C1 that is engaged before and after the downshift (immediately before and immediately after the downshift) is the input clutch C.

FIG. 4 is an alignment graph of the second transmitting portion 30 in the downshift from second speed 2nd to first speed 1st. During the downshift, the vehicle speed V before and after the shift does not substantially change, so the rotation speed Nout of the sixth rotating element RE6 (i.e., the second carrier CA2 and the third carrier CA3) that is connected to the output rotating member 32 and functions as an output-side rotating element is similarly constant before and after the shift. Also, the solid line indicates the rotational states in second speed 2nd, and the broken line indicates the rotational states when shifted into first speed 1st. In second speed 2nd, the first brake B1 is engaged, so the fourth rotating element RE4 is stopped from rotating. Then, when the shift is made into first speed 1st, the first brake B1 is released and the second brake B2 is engaged, such that the fifth rotating element RE5 is stopped from rotating. In the downshift from second speed 2nd to first speed 1st shown in FIG. 4, the first clutch C1 that is the input clutch C is an example of the first engagement apparatus of the invention. The second brake B2 that is the engaging-side engagement apparatus is an example of the second engagement apparatus of the invention. The fifth rotating element RE5 is an example of the speed reducing-side rotating element of the invention. The sixth rotating element RE6 is an example corresponding to the output-side rotating element of the invention. The seventh rotating element RE7 is an example of the speed increasing-side rotating element of the invention.

In describing the downshift from second speed 2nd to first speed 1st based on this alignment graph in FIG. 4, when the downshift is made from second speed 2nd into first speed 1st, the rotation speed of the fifth rotating element RE5 is reduced during the downshift, as shown by the arrow. On the other hand, the rotation speed of the seventh rotating element RE7 that is connected to the turbine shaft 16 via the first clutch C1 is increased during the downshift, as shown by the arrow. In this way, the rotation speed of the fifth rotating element RE5 is reduced while the rotation speed of the seventh rotating element RE7 is increased, centered around the sixth rotating element RE6 that is connected to the output rotating member 32.

Here, in the blipping downshift control of this example embodiment, the engine speed Ne and the turbine rotation speed Nt of the turbine shaft 16 are increased in advance by the engine output control portion 80, so if the first clutch C1 is engaged first, the rotation speed of the seventh rotating element RE7 is increased, and the rotation speed of the fifth rotating element RE5 is reduced by that reaction force. At this time, the fifth rotating element RE5 functions as a reaction force element, so forward driving force is generated in the sixth rotating element RE6. That is, the increase in the rotation speed of the seventh rotating element RE7 causes driving force in a direction that increases the rotation speed (i.e., forward driving force) to also be generated in the sixth rotating element RE6.

Above, a downshift from second speed 2nd to first speed 1st is described as an example, but a similar problem also occurs with a downshift into other speeds. For example, in the automatic transmission 14, a similar problem also occurs with a downshift from third speed 3rd to second speed 2nd, a downshift from fourth speed 4th to third speed 3rd, and a downshift from fourth speed 4th to second speed 2nd. This is because with all of these downshifts, when there is a rotating element (i.e., the sixth rotating element RE6) that functions as the output-side rotating element between the speed increasing-side rotating element that is increased in rotation speed during the downshift, and a speed reducing-side rotating element that is reduced in rotation speed during the downshift, and the input clutch C is engaged first such that the rotation speed of the speed increasing-side rotating element is increased, the speed reducing-side rotating element functions as a reaction force element, so forward driving force is generated in the sixth rotating element RE6 that is the output-side rotating element.

Therefore, when executing a downshift in the automatic transmission 14 and the downshift is one in which there is an output-side rotating element (i.e., the sixth rotating element RE6) that is connected to the output rotating member 32 between a speed increasing-side rotating element and a speed reducing-side rotating element, the shift control portion 82 increases the torque capacity of the input clutch C when, or after, engaging the engaging-side engagement apparatus to be engaged during the downshift, when engaging the input clutch C that connects the turbine shaft 16 to the automatic transmission 14, from a state in which the torque capacity of the input clutch C had been reduced. Here, the speed increasing-side rotating element is a rotating element that is connected to the input clutch C (i.e., the first clutch C1 or the second clutch C2) and is increased in rotation speed during a downshift, in the alignment graph of the automatic transmission 14. Also, the speed reducing-side rotating element is a rotating element that is connected to an engaging-side engagement apparatus to be engaged during a downshift and is reduced in rotation speed during a downshift, in the alignment graph of the automatic transmission 14.

In the description below as well, a downshift from second speed 2nd to first speed 1st will be described as an example. When downshifting from second speed 2nd to first speed 1st, the shift control portion 82 outputs a command to the hydraulic control circuit 72 to release the first brake B1 that is the releasing-side engagement apparatus to be released during the downshift, and at the same time or after a slight delay time, outputs a command to the hydraulic control circuit 72 to engage the second brake B2 that is the engaging-side engagement apparatus to be engaged during the downshift. In conjunction with this, the shift control portion 82 outputs a command to the hydraulic control circuit 72 to reduce (release or slip-engage) the torque capacity of the first clutch C1 that is engaged before and after the downshift and functions as the input clutch C that connects the turbine shaft 16 to the automatic transmission 14. Also, at the same time as, or after a slight delay time after, the command to reduce the torque capacity of the first clutch C1 is output, the engine output control portion 80 outputs a command to increase the engine speed Ne. Then, when the start of an inertia phase of the automatic transmission 14 is detected following an increase in hydraulic pressure in the second brake B2, for example, the shift control portion 82 gradually increases this hydraulic pressure such that the second brake B2 is fully engaged. Also, the shift control portion 82 starts to increase the torque capacity of the first clutch C1 when a preset delay time Tdelay passes after the second brake B2 starts to be engaged, for example. This delay time Tdelay is one example of the predetermined period of time of the invention.

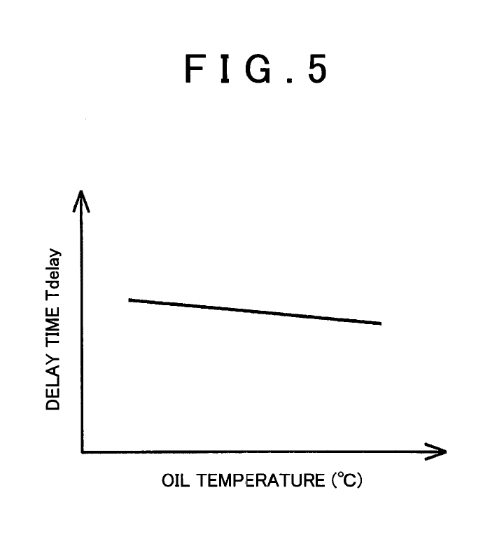

The delay time Tdelay is determined based on a map that is obtained and stored beforehand. This delay time Tdelay is set based on a test or the like, and is set such that driving force that acts in a direction to increase the rotation speed of the sixth rotating element RE6 based on the torque capacity of the first clutch C1 will not exceed driving force that acts in a direction to reduce the rotation speed of the sixth rotating element RE6 based on the torque capacity of the second brake B2. Therefore, by having the increase in the torque capacity (i.e., engagement) of the first clutch C1 being started after the delay time Tdelay has passed from the time that the second brake B2 starts to be engaged, the driving force that acts in the direction that reduces the rotation speed of the sixth rotating element RE6 based on the torque capacity of the second brake B2 becomes larger than the driving force that acts in the direction that increases the rotation speed of the sixth rotating element RE6 based on the torque capacity of the first clutch C1, so forward driving force is prevented from being generated in the sixth rotating element RE6. FIG. 5 is one example of a map of the delay time Tdelay obtained in advance. In FIG. 5, the horizontal axis represents the oil temperature Toil, and the vertical axis represents the delay time Tdelay. The delay time Tdelay changes according to the oil temperature Toil. This takes into account the hydraulic response of the engagement apparatuses which changes according to the oil temperature Toil. This map is set for each downshift pattern (e.g., a downshift from second speed 2nd to first speed 1st).

Here, the control described above is not applied with a downshift from fifth speed 5th to fourth speed 4th, or from sixth speed 6th to fifth speed 5th. Taking a downshift from sixth speed 6th to fifth speed 5th as an example, the input clutch C that connects the turbine shaft 16 to the automatic transmission 14 before and after the downshift is the second clutch C2. When this second clutch C2 is engaged, the rotation of the turbine shaft 16 is input to the fifth rotating element RE5 (i.e., the second ring gear R2 and the third ring gear R3), such that the rotation speed of the fifth rotating element RE5 increases. Also, with the downshift into fifth speed 5th, the engaging-side engagement apparatus is the third brake B3. When this third brake B3 is engaged, the second rotating element RE2 (i.e., the first carrier CA1) rotates at a predetermined rotation speed, and the fourth rotating element RE4 (i.e., the second sun gear S2) that is connected to this second rotating element RE2 is also kept rotating at this rotation speed, so the rotation speed of the fourth rotating element RE4 also increases in the same way. Therefore, in the downshift from sixth speed 6th to fifth speed 5th, when looking at the alignment graph of the second transmitting portion 30, the sixth rotating element RE6 that functions as the output-side rotating element is not positioned between the fourth rotating element RE4 and the fifth rotating element RE5 that function as speed increasing-side rotating elements, so this does not correspond to the structure that is a prerequisite for the control described above, and thus the problem to be solved by this application does not occur. Therefore, the control described above is not applied to these downshifts.

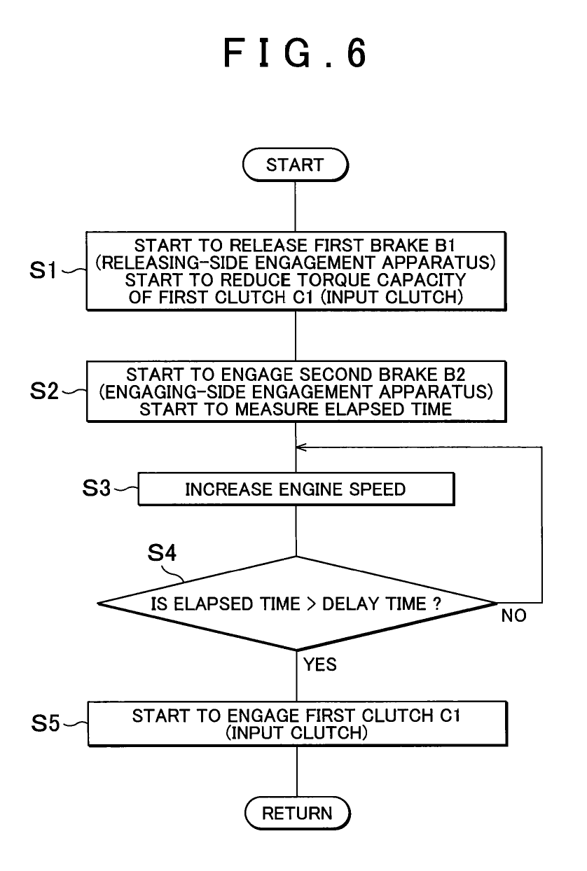

FIG. 6 is a flowchart illustrating the main portions of a control operation performed by the electronic control unit 50, i.e., a control operation that prevents forward driving force that is transmitted to the output rotating member 32 during a downshift of the automatic transmission 14 from being generated. This flowchart is repeatedly executed in extremely short cycle times of approximately several milliseconds to several tens of milliseconds, for example. In describing the flowchart below as well, a downshift from second speed 2nd to first speed 1st will be described as an example.

First, in step S1 that corresponds to the shift control portion 82, release control of a releasing-side engagement apparatus to be released during the downshift, more specifically, the first brake B1, is started, and reduction control of the torque capacity of the first clutch C1 that is the input clutch C that transmits the rotation of the turbine shaft 16 is started. Also, in step S2 that corresponds to the shift control portion 82, engagement control of an engaging-side engagement apparatus to be engaged during the downshift, more specifically, the second brake B2, is started. At the same time as this, the shift control portion 82 starts to measure an elapsed time T from the time that the second brake B2 starts to be engaged. Steps S1 and S2 may be started simultaneously.

Next, in step S3 that corresponds to the engine output control portion 80, control to increase the engine speed Ne is executed. In step S4 that corresponds to the shift control portion 82, it is determined whether the preset delay time Tdelay exceeds the elapsed time T. If the determination in step S4 is NO, the process returns to step S3, and the engine speed Ne continues to be increased. On the other hand, if the determination in step S4 is YES, the torque capacity of the first clutch C1 starts to be increased. In this way, the torque capacity of the first clutch C1 is increased after the torque capacity of the second brake B2 is increased, so forward driving force generated by the sixth rotating element RE6 based on the engagement of the first clutch C1 is prevented from being generated. Also, at the point in time at which the first clutch C1 is engaged, the rotation speed of the seventh rotating element RE7 is already increased by the engagement of the second brake B2, so forward driving force as a result of the engagement of the first clutch C1 will also not be generated.

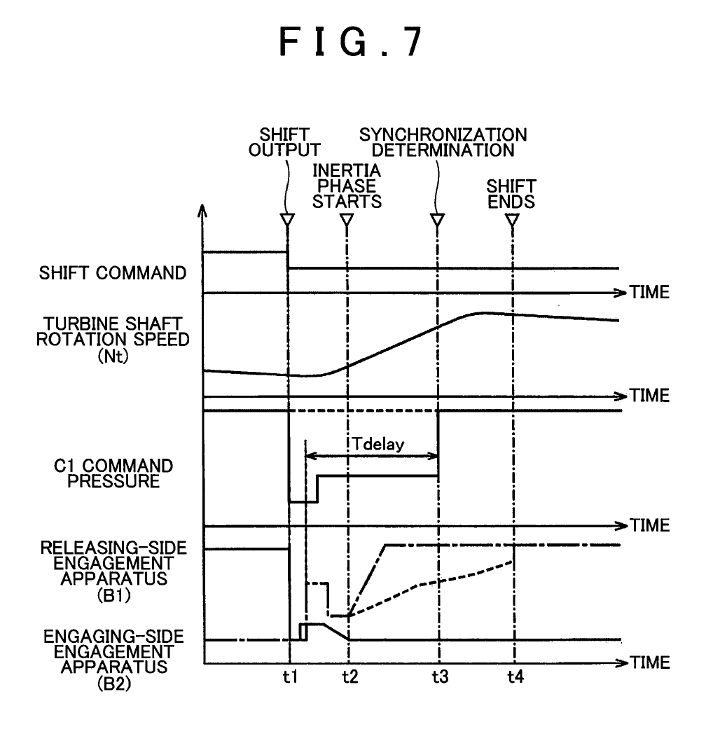

FIG. 7 is a time chart illustrating the result of the control operation based on the electronic control unit 50, i.e., the operation result based on the flowchart in FIG. 6. In FIG. 7 as well, a downshift from second speed 2nd to first speed 1st (i.e., release of the first brake and engagement of the second brake) is shown as an example.

When a downshift command of the automatic transmission 14 is output at time t1 shown in FIG. 7, release control of the first brake B1 that is the releasing-side engagement element is started, and reduction control of the torque capacity of the first clutch C1 that is the input clutch C is started. The engagement pressures (i.e., engagement hydraulic pressures) of all of the engagement apparatuses shown in FIG. 7 are command pressures. Also, the bold line shown in FIG. 7 represents a related blipping downshift in which the torque capacity of the first clutch C1 is not reduced during the downshift.

As shown in FIG. 7, the engagement pressure of the first brake B1 shown by the solid line is once reduced to zero pressure (i.e., release pressure), and then temporarily maintained at a predetermined standby pressure. Then, after time t2 when the inertia phase starts, the engagement pressure of the first brake B1 is again controlled to zero pressure. Also, the first clutch C1 is also similarly once controlled to zero pressure, and then controlled to a predetermined standby pressure. This standby pressure is set to a hydraulic pressure lower limit value at which torque is able to be transmitted in the first clutch C1, for example. Alternatively, the standby pressure may be a value at which a predetermined torque capacity (slip engagement) is able to be obtained in the first clutch C1.

After a slight delay time from time t1, the second brake B2 starts to be engaged (i.e., the torque capacity starts to be increased). The engagement pressure of the second brake B2 shown by the alternate long and short dash line is temporarily increased (quick apply) to a predetermined value set beforehand, and then maintained at a predetermined standby pressure. Then, after time t2 when the inertia phase starts, the hydraulic pressure with which the second brake B2 is engaged is increased to a target pressure. Also, between time t1 and time t2, the engine speed Ne starts to increase, so the turbine rotation speed Nt increases.

When the inertia phase of the automatic transmission 14 starts at time t2, the engagement pressure of the second brake B2 is gradually increased. At this time, the torque capacity of the second brake B2 increases, so in the sixth rotating element RE6, force acts in a direction that reduces the rotation speed thereof, thus forward driving force is not generated. Also, at time t2, the engagement pressure of the first brake B1 is controlled to zero pressure.

If it is determined at time t3 that the delay time Tdelay has passed from the start of engagement of the second brake B2, engagement (i.e., an increase in the torque capacity) of the first clutch C1 is started. As a result, the first clutch C1 will become engaged when the torque capacity of the second brake B2 has increased sufficiently and the rotation speed of the seventh rotating element RE7 has increased sufficiently, so forward driving force will not be generated even if the first clutch C1 is engaged.

In this way, according to this example embodiment, in the automatic transmission 14 having a structure in which a rotating element (i.e., sixth rotating element RE6) that functions as an output-side rotating element is provided between a speed increasing-side rotating element (e.g., the seventh rotating element RE7) and a speed reducing-side rotating element (e.g., fifth rotating element RE5), the rotation speed of the speed reducing-side rotating element is reduced first by the engagement of the engaging-side engagement apparatus, by the increase in the torque capacity of the input clutch C being started when, or after, the engaging-side engagement apparatus is engaged at the time of a downshift into a predetermined speed. Here, the speed increasing-side rotating element is a rotating element that is connected to the engine 8 via the input clutch C (e.g., the first clutch C1) and is increased in rotation speed during a downshift into a predetermined speed (e.g., a downshift from second speed 2nd to first speed 1st), in the alignment graph. Also, the speed reducing-side engagement apparatus is a rotating element that is reduced in rotation speed by the engaging-side engagement apparatus (e.g., the second brake B2) being engaged during a downshift into a predetermined speed, in the alignment graph. This change in the rotation speed of the rotating elements described above causes driving force to act on the output-side rotating element in a direction that reduces the rotation speed thereof, so forward driving force is able to be prevented from being generated by the output rotating member 32. Then, the torque capacity of the input clutch C is increased, but at this time, the rotation speed of the speed increasing-side rotating element increases with the progression of the shift, so when engagement of the input clutch C starts, the rotation speed of the speed increasing-side rotating element will not increase so forward driving force will not be generated by the output-side rotating element. Therefore, it is possible to prevent forward driving force from being generated by the output-side rotating element during the downshift.

Also, according to this example embodiment, by starting to increase the torque capacity of the input clutch C after the delay time Tdelay has passed from the time that the engaging-side engagement apparatus of the automatic transmission 14 starts to be engaged, the engaging-side engagement apparatus is engaged before the input clutch C at the time of a downshift, so forward driving force resulting from the input clutch C being engaged first is able to be prevented from being generated.

Hereinafter, an example embodiment of the invention has been described in detail with reference to the drawings, but the invention may also be applied in other modes. Therefore, modified examples of the foregoing example embodiment of the invention will be described below.

For example, in the example embodiment described above, the automatic transmission 14 functions as a transmission having six forward speeds, but the number of speeds is not particularly limited, e.g., there may be eight forward speeds or the like. The specific connection configuration is also not limited to the example embodiment described above. The invention may be suitably applied as long as it is an automatic transmission that has a shift pattern of a downshift in which an output-side rotating element is between a speed increasing-side rotating element that is connected to an input clutch before and after a downshift and is increased in rotation speed during the downshift, and a speed reducing-side rotating element that is reduced in rotation speed by an engaging-side engagement element being engaged, in an alignment graph.

Also, in the example embodiment described above, the delay time Tdelay is set based on the time at which the engaging-side engagement device starts to be engaged, but the delay time Tdelay does not necessarily have to be based on the time at which the engaging-side engagement device starts to be engaged. That is, the delay time Tdelay may also be set based on time t2 when the inertia phase starts, shown in FIG. 7, for example. Furthermore, the delay time Tdelay may also be set based on the time when the engagement pressure (command pressure) of the engaging-side engagement apparatus reaches a target hydraulic pressure set after the downshift.

Also, in the example embodiment described above, the increase in the torque capacity of the input clutch C is started based on the delay time Tdelay, but the start of this increase is not necessarily limited to being based on the delay time Tdelay. For example, the increase in the torque capacity of the input clutch C may also be started when it is detected that the rotation speed of a speed increasing-side rotating element (e.g., the seventh rotating element RE7) that increases in rotation speed during a downshift is synchronized with a target rotation speed after the downshift. More specifically, the increase in the torque capacity of the input clutch C is started when a difference in rotation speed AN between the rotation speed of the speed increasing-side rotating element and the target rotation speed of the speed increasing-side rotating element set after the downshift is equal to or less than a preset threshold value. Even when controlled in this way, when the speed increasing-side rotating element is synchronized with the target rotation speed after the downshift, the torque capacity of the engaging-side engagement apparatus is sufficiently high, so forward driving force will not be generated by the output-side rotating element even if the input-side clutch is engaged.

Also, in the example embodiment described above, the increase in the engine speed Ne is started after a predetermined period of time has passed after the reduction in the torque capacity of the input clutch C has started, but the increase in the engine speed Ne may also be started in conjunction with the starting of the reduction in the torque capacity of the input clutch C.

Also, in the example embodiment described above, the map for obtaining the delay time Tdelay is set based on the oil temperature Toil, but it may also be set based on a map of another requirement such as the standby pressure (hydraulic pressure) of the first clutch C1, for example. Also, the delay time Tdelay does not necessarily have to be set based on a map, and may instead be set based on a preset calculation formula.

In the example embodiment described above, a downshift from second speed 2nd into first speed 1st (the predetermined speed) is given as an example of the downshift into a predetermined speed, but the automatic transmission 14 may also be applied with a downshift from third speed 3rd into second speed 2nd, from fourth speed 4th into third speed 3rd, or from fourth speed 4th into second speed 2nd. If the shift pattern of the downshift changes, the corresponding relationship of the second engagement apparatus and the like of the invention is appropriately changed. For example, taking a downshift from third speed 3rd into second speed 2nd as an example, the first clutch C1 that is engaged in third speed 3rd and second speed 2nd corresponds to the input clutch C (the first engagement apparatus of the invention), while the first brake B1 that is engaged during the downshift corresponds to the second engagement apparatus. Along with this, the seventh rotating element RE7 corresponds to the speed increasing-side rotating element, and the fourth rotating element RE4 corresponds to the speed reducing-side rotating element.

The example embodiments and the like described above are no more than examples. The invention may be carried out in modes that have been modified or improved in any of a variety of ways based on the knowledge of one skilled in the art.

1. A shift control apparatus of a vehicle automatic transmission, the vehicle automatic transmission including:
a planetary gear set that includes a first engagement apparatus and a second engagement apparatus;
a speed increasing-side rotating element configured to be connected to an engine via the first engagement apparatus and increased in rotation speed during a downshift into a predetermined speed, in an alignment graph showing a rotational state of each rotating element of the vehicle automatic transmission;
a speed reducing-side rotating element configured to be reduced in rotation speed by the second engagement apparatus being engaged during the downshift into the predetermined speed; and
an output-side rotating element provided between the speed increasing-side rotating element and the speed reducing-side rotating element,
the shift control apparatus comprising:
a controller configured to increase an engine speed of the engine while reducing a torque capacity of the first engagement apparatus that is engaged before the downshift and after the downshift, during the downshift into the predetermined speed of the vehicle automatic transmission, the controller being configured to increase the torque capacity of the first engagement apparatus when, or after, engaging the second engagement apparatus.

2. The shift control apparatus according to claim 1, wherein
the controller is configured to start increasing the torque capacity of the first engagement apparatus after a predetermined period of time has passed from a start of engagement of the second engagement apparatus at the time of the downshift of the vehicle automatic transmission.

3. The shift control apparatus according to claim 2, wherein
the controller is configured to set the predetermined period of time based on the time at which the second engagement apparatus starts to be engaged.

4. The shift control apparatus according to claim 2, wherein
the controller is configured to set the predetermined period of time based on the time at which an inertia phase starts at the time of the downshift.

5. The shift control apparatus according to claim 2, wherein
the controller is configured to set the predetermined period of time based on a point when an engagement hydraulic pressure of the second engagement apparatus reaches a target hydraulic pressure of the second engagement apparatus set after the downshift.

6. The shift control apparatus according to claim 2, wherein
the controller is configured to set the predetermined period of time based on a point when the rotation speed of the speed increasing-side rotating element during the downshift is synchronized with a target rotation speed of the speed increasing-side rotating element after the downshift.

7. The shift control apparatus according to claim 2, wherein
the controller is configured to set the predetermined period of time based on an oil temperature of the vehicle automatic transmission.
